(19) United States
(12) Patent Application Publication
(10) Pub. No.: US 2026/0095990 A1
(43) Pub. Date: Apr. 2, 2026

(54) LED LIGHT STRING DRIVER, LED LIGHT STRING AND CHRISTMAS TREE

(71) Applicant: Winners Group Industries Company Limited, Guigang City (CN)

(72) Inventor: Junhao CAI, Dongguan City (CN)

(21) Appl. No.: 19/021,840

(22) Filed: Jan. 15, 2025

(30) Foreign Application Priority Data
Sep. 27, 2024 (CN) 202422375268.5
Sep. 27, 2024 (CN) 202422375319.4

(51) Int. Cl. H05B 45/50; F21S 4/10; F21V 23/00; F21V 23/02; F21Y 115/10; H05B 45/325; H05B 47/16; H05B 47/19

(52) U.S. Cl. CPC H05B 45/50; F21S 4/10; F21V 23/008; F21V 23/02; H05B 45/325; H05B 47/16; H05B 47/19; F21Y 2115/10

(57) ABSTRACT

The present application discloses a LED light string driver, a LED light string and a Christmas tree. The LED light string driver of the present application includes a housing, and a control board provided in the housing; wherein, an power supply terminal of the control board is connected to an external DC power supply, and an output terminal of the control board is connected to a light string body provided externally, a circuit is provided on the control board, the circuit including a master control chip, and a control signal receiving module and a LED driving module electrically connected to the master control chip; wherein, a false triggering preventing module is provided in the master control chip.

### CROSS-REFERENCE TO RELATED APPLICATION

This application claims priority to Chinese Patent Application No. 202422375268.5 filed on Sep. 27, 2024, and Chinese Patent Application No. 202422375319.4 filed on Sep. 27, 2024, the entire contents of both are hereby incorporated by reference.

### FIELD OF TECHNOLOGY

The present application relates to the technical field of LED lights, and in particular to a LED light string driver, a LED light string and a Christmas tree.

### BACKGROUND

Decorating a house or a yard with a Christmas tree during Christmas is a traditional custom in many western countries. In modern urban families, people usually use an artificial Christmas tree product instead of a traditional natural tree as the Christmas tree. There is an artificial Christmas tree product equipped with a LED light string in the market. When in use, the LED light string is wrapped on the Christmas tree and electrically illuminated to have an effect of decorating the Christmas tree.

In some existing LED light string products, a LED light string body is connected to a power supply through a driver, the driver may control the LED light string to achieve a richer lighting effect. However, the driver of an existing LED light string of the Christmas tree has the following defects:
1. The driver is usually integrally connected to the light string body and the power supply. When a user decorates the Christmas tree, the LED light string connected to the driver needed to be wrapped around a Christmas tree body. However, a weight of the driver is relatively heavy and it is not convenient for the user to wrap the LED light string, leading to a poor installation experience.
2. When a key configured to control the driver is falsely triggered (e.g., the key is pressed by a foreign object, or the key is triggered frequently by a kid out of curiosity), the LED light string is frequently being turned on and off in a short time and is subjected to an impact of a transient high current frequently, causes a significant decline in service life of the LED light string and even damages an internal component of the LED light string. The driver of the existing LED light string of the Christmas tree lacks a protection mechanism for false trigger.
3. The driver of the existing LED light string of the Christmas tree is usually only controlled by the key, a control method is relatively monotonous and is unable to adapt to multiple scenarios, leading to a poor user experience.

### SUMMARY

According to a first aspect of this disclosure, a LED light string driver is disclosed and includes:
a housing, and a control board provided in the housing; wherein, a power supply terminal of the control board is connected to an external DC power supply, and an output terminal of the control board is connected to a light string body provided externally;
wherein, a circuit is provided on the control board, the circuit including a master control chip, and a control signal receiving module and a LED driving module electrically connected to the master control chip; the control signal receiving module is configured to receive a control signal generated by an operation of a user; the master control chip is configured to generate a PWM signal according to the control signal; the LED driving module is electrically connected to the light string body provided externally and is configured to drive the light string body to illuminate according to the PWM signal;
wherein, a false triggering preventing module is provided in the master control chip, the false triggering preventing module is configured to determine whether the LED light string driver is currently in a false triggering state, and perform a false triggering protection operation if the LED light string driver is currently in the false triggering state.

According to a second aspect of this disclosure, a LED light string is disclosed and includes:
a light string body and the LED light string driver of the first aspect; an input terminal of the LED light string driver is connected to an external DC power supply, an output terminal of the LED light string driver is connected to the light string body to drive the light string body to illuminate.

According to a third aspect of this disclosure, a Christmas tree is disclosed and includes:
a Christmas tree body and a LED light string wrapped on the Christmas tree body;
the LED light string includes: a light string body and the LED light string driver of the first aspect; an input terminal of the LED light string driver is connected to an external DC power supply, an output terminal of the LED light string driver is connected to the light string body to drive the light string to illuminate.

### BRIEF DESCRIPTION

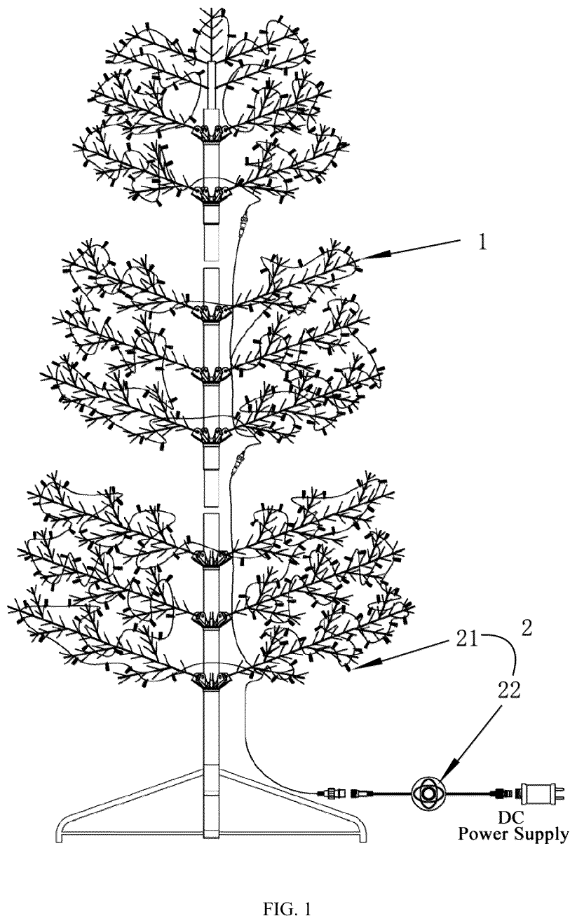

FIG. 1 is a schematic diagram of a Christmas tree in Embodiment 1 of the present application;

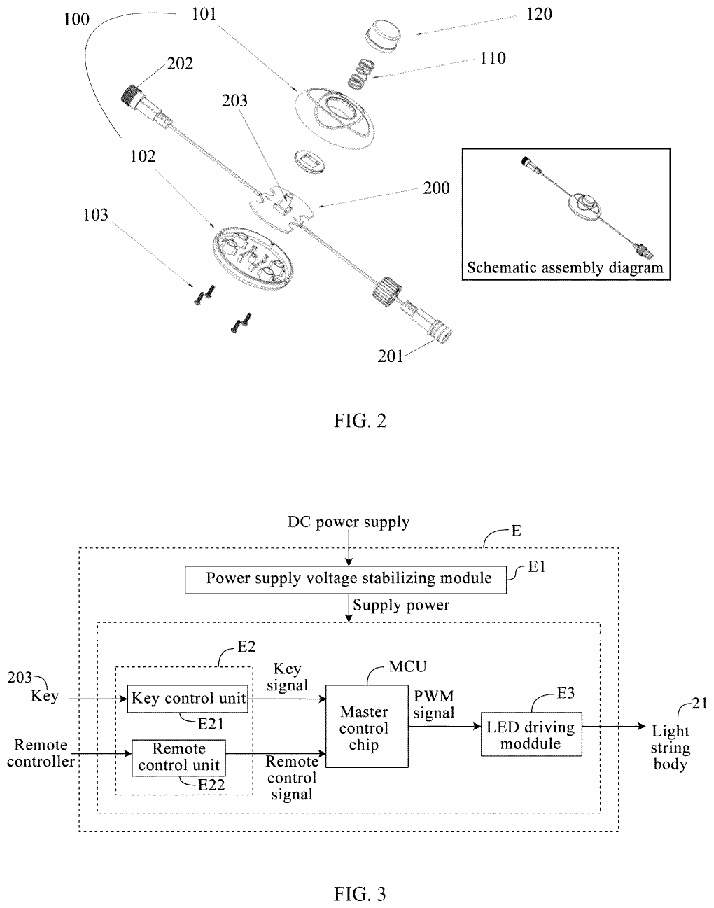

FIG. 2 is a schematic structural diagram of a LED light string driver in Embodiment 1 of the present application;

FIG. 3 is a schematic modular diagram of a circuit of a control board of the LED light string driver in Embodiment 1 of the present application;

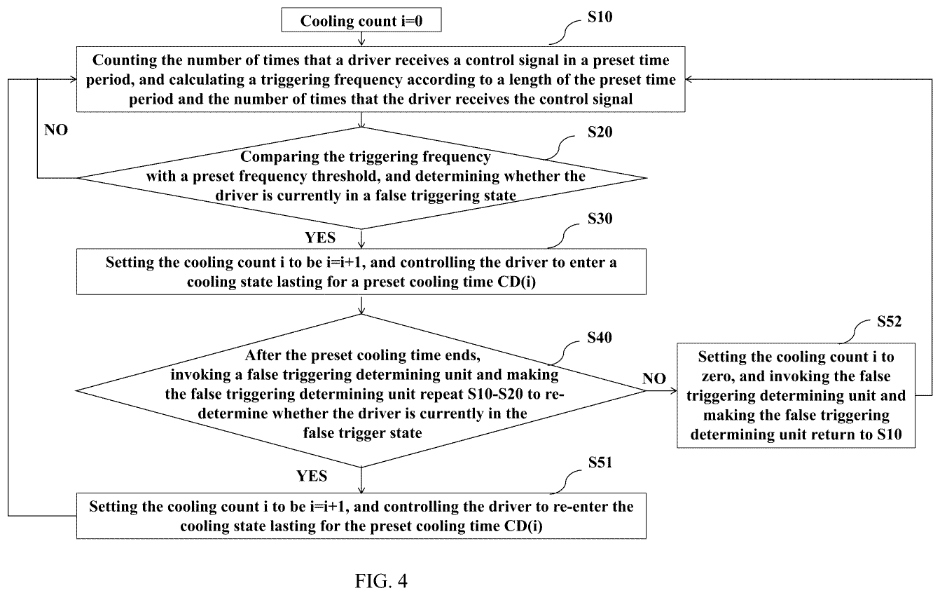

FIG. 4 is a schematic flowchart of a false triggering preventing protection method performed by a false triggering preventing module in Embodiment 1 of the present application;

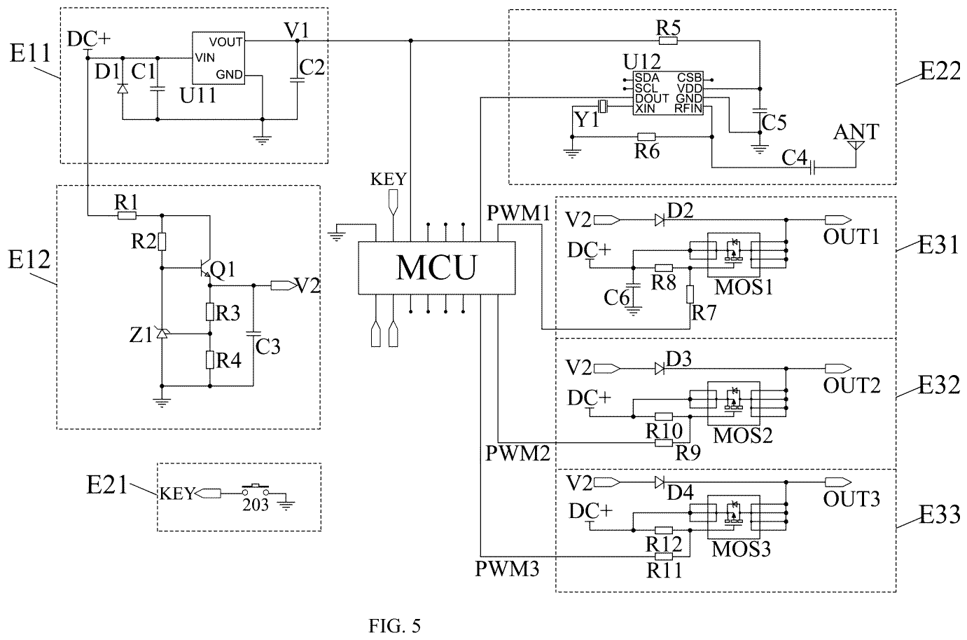

FIG. 5 is a specific schematic structural diagram of the circuit of the control board of the LED light string driver in Embodiment 1 of the present application; and

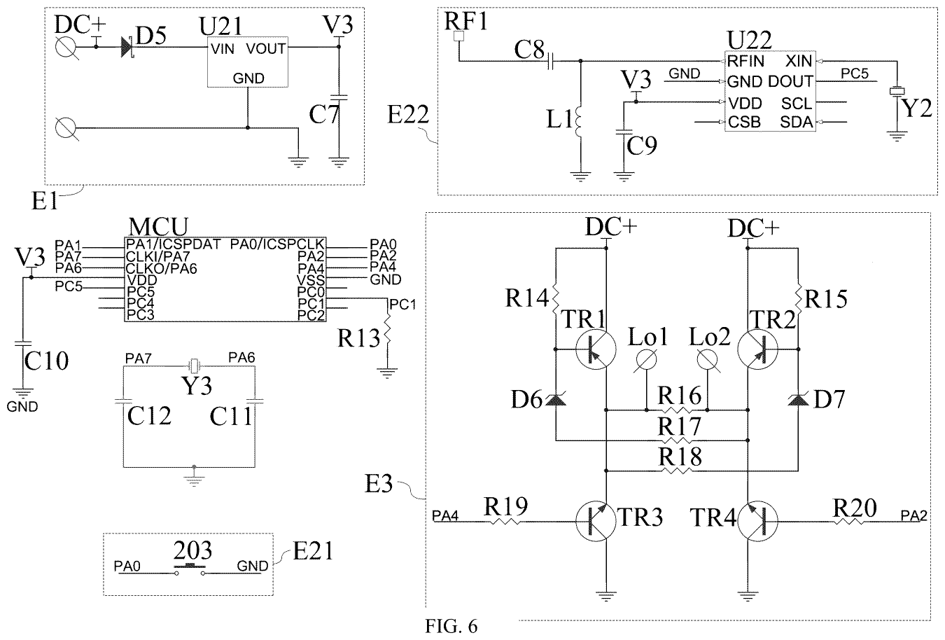

FIG. 6 is a specific schematic structural diagram of a circuit of a control board of a LED light string driver in Embodiment 2 of the present application.

### DETAILED DESCRIPTION

It should be clear that the following embodiments are only some of the embodiments of the present application. All the other embodiments obtained by those skilled in the art based on the following embodiments without any creative effort shall fall within the scope of protection of the present application.

The terms used in the embodiments of the present application are merely for the purpose of describing detailed embodiments, and are not intended to limit the present application. As used in the embodiments of this application and the appended claims, the singular forms “a”, “said”, and “the” are intended to include their plural forms as well, unless the context clearly dictates otherwise. And it should also be understood that the term “and/or” as used herein refers to and includes any or all possible combinations of one or more associated listed items.

When the following description relates to the drawings, the same numbers represent the same or similar elements in the different drawings, unless otherwise indicated. The implementation modes described in the following exemplary embodiments do not represent all the implementation modes consistent with the disclosure. On the contrary, they are only the examples of the devices and methods which are detailed in the attached claims and consistent with some aspects of the disclosure. It should be noted that the terms such as “first”, “second”, “third” and the like in the description of the present application are only used to distinguish similar objects, but not intended to describe a specific order or sequence and cannot be construed as indicating or implying relative importance. For those ordinarily skilled in the art, the specific meaning of the forgoing terms in the present disclosure can be understood according to the specific situation.

In addition, in the description of the present disclosure, the term “a plurality of” refers to two or more unless otherwise specified. The term “and/or” is intended to describe an association between associated objects, which indicates that there may be three relationships, for example, A and/or B may indicate presence of A only, of both A and B, and of B only. The character “/” generally indicates that contextual objects have an “or” relationship.

### Embodiment 1

Please refer to FIG. 1, FIG. 1 is a schematic diagram of a Christmas tree in Embodiment 1 of the present application. The Christmas tree in Embodiment 1 of the present application includes a Christmas tree body 1 and a LED light string 2 wrapped on the Christmas tree body 1. The LED light string 2 is a LED light string of the present application. The LED light string 2 includes a light string body 21 and a driver 22. An input terminal of the driver 22 is configured to be connected to an external DC power supply, an output terminal of the driver 22 is connected to the light string body 21 through a connecting terminal to drive the light string body 21 to illuminate. The driver 22 is a LED light string driver of the present application.

As shown in FIG. 1. The driver 22 of the present application is separated from the light string body 21, and the output terminal of the driver 22 is connected to an input terminal of the light string body 22 through the connecting terminal only in use. When a user decorates the Christmas tree, first, the user may wrap the light string body 21 with less weight around the Christmas tree body 1, and then connect the light string body 21 to the driver 22, thus improving an installation experience.

Please refer to FIG. 2, FIG. 2 is a schematic structural diagram of the LED light string driver in Embodiment 1 of the present application. The driver 22 includes a housing 100 and a control board 200 provided in the housing 100. The housing 100 includes an upper housing 101 and a lower housing 102. The upper housing 101 and the lower housing 102 are fixed and connected to each other through a buckle or a screw 103, forming the housing 100 with an cavity inside.

The control board 200 is installed in an interior of the housing 100 and provided with a power supply terminal 201 configured to be connected to the external DC power supply, an output terminal 202 configured to be connected to the light string body 21, and a key 203 configured to control an output of the control board 200.

Furthermore, the driver 22 includes a spring 110 and a keycap 120. The key 203 has a pillar shape, the spring 110 is sleeved on the key 203. A mounting hole configured to install the keycap 120 is provided on a position of the upper housing 101 corresponding to the key 203. The keycap 120 is covered on a top of the key 203 and abuts on a top of the spring 110, and protrudes from the mounting hole of the upper housing 101.

Please refer to FIG. 3, FIG. 3 is a schematic modular diagram of a circuit of the control board of the LED light string driver in Embodiment 1 of the present application. A circuit E is provided on the control board 200 of the driver 22. The circuit E includes: a power supply voltage stabilizing module E1, a control signal receiving module E2, a master control chip MCU and a LED driving module E3. The power supply voltage stabilizing module E1 is configured to convert the external DC power supply into a preset power supply voltage to supply power to other modules. The control signal receiving module E2 is configured to receive a control signal generated by an operation of the user and transmit the control signal to the master control chip MCU. The master control chip MCU is configured to generate a PWM signal according to the control signal. The LED driving module E3 is electrically connected to the light string body 21 and drives the light string body 21 to illuminate according to the PWM signal.

Specifically, the control signal receiving module E2 includes a key control unit 21 and a remote control unit E22 electrically connected to the master control chip MCU. The control signal includes a key signal and a remote control signal. The key control unit E21 is configured to obtain the key signal generated by the user triggering the key 203 and transmit the key signal to the master control chip MCU. The remote control unit E22 is configured to receive a radio frequency signal generated by an operation of the user on a remote controller and perform demodulation processing on the radio frequency signal to obtain the remote control signal, and then output the remote control signal to the master control chip MCU.

Furthermore, in order to prevent the key 203 or the remote controller from being falsely triggered continuously and frequently, a false triggering preventing module, including a false triggering determining unit and a false triggering action unit, is provided in the master control chip MCU. The false triggering determining unit is configured to determine whether the driver 22 is currently in a false triggering state, and the false triggering action unit is configured to perform a false triggering protection operation when the false triggering determining unit determines that the driver 22 is currently in the false triggering state.

Please refer to FIG. 4, FIG. 4 is a schematic flowchart of a false triggering preventing protection method performed by the false triggering preventing module in Embodiment 1 of the present application.

The following steps are performed by the false triggering determining unit to determine whether the driver 22 is currently in the false triggering state:

S10, counting the number of times that the driver 22 receives the control signal in a preset time period, and calculating a triggering frequency according to a length T of the preset time period and the number of times N that the driver 22 receives the control signal.

A calculation formula of the triggering frequency is:

$$f = \frac{N}{T} ,$$

wherein, f represents the triggering frequency, T represents the length of the preset time period, and N represents the number of times that the driver 22 receives the control signal in the preset time period.

S20, comparing the triggering frequency with a preset frequency threshold, and if the triggering frequency is greater than the preset frequency threshold, determining the driver 22 is currently in the false triggering state.

The false triggering protection operation performed by the false triggering action unit includes:

S30, setting a cooling count i to be

i=i+1

when the false triggering determining unit determines that the driver 22 is currently in the false triggering state, and controlling the driver 22 to enter a cooling state lasting for a preset cooling time CD(i).

The cooling count i is initially equal to 0. The preset cooling time CD(i) is a function of the cooling count i; the preset cooling time CD(i) is increased as the cooling count i increased.

When the driver 22 is in the cooling state, the master control chip MCU receives the control signal as usual without adjusting the PWM signal according to the control signal.

S40, invoking the false triggering determining unit and making the false triggering determining unit repeat S10-S20 after the preset cooling time ends to re-determine whether the driver 22 is currently in the false triggering state.

S51, if the driver 22 is still currently in the false triggering state, setting the cooling count i to be

i=i+1,

and controlling the driver 22 to re-enter the cooling state lasting for the preset cooling time CD(i), and invoking the false triggering determining unit and making the false triggering determining unit return to S10 after the preset cooling time ends.

S52, if the driver 22 is not currently in the false triggering state, setting the cooling count i to zero, and invoking the false triggering determining unit and making the false triggering determining unit return to S10.

A person skilled in the art may preset the preset time period T, a specific value of the preset frequency threshold and a specific mapping relation between the preset cooling time CD(i) and the cooling count i according to actual needs.

When the driver 22 is in the cooling state, the master control chip MCU receives the control signal as usual without adjusting the PWM signal according to the control signal. That is to say, the control signal received in the cooling state will not affect the light string body 21. Even if the key 203 or the remote controller is falsely triggered, the light string body 21 will not be turned on and off frequently in a short period of time, thus preventing a decline in service life and safety problems caused by frequent on and off of the light string body 21.

To prevent a normal operation of the user from being incorrectly determined as a false trigger and thus resulting in a slow control response and affecting user experience, the present application establishes a positive correlation between the preset cooling time CD(i) and the cooling count i. In the first few times of entering into the cooling state, since a value of the cooling count i is relatively small, the preset cooling time CD(i) is very short. After a relatively short preset cooling time ends, the user may still operate the driver normally, leading a little impact on the user experience. A probability of entering the cooling state continuously and repeatedly due to the normal operation of the user is very small. However, a false trigger due to a malfunction of the key 203 or the remote controller and an intentional cause (e.g. children playing) usually lasts a long time, and easily lead to multiple entries into the cooling state continuously and repeatedly. Therefore, when the cooling count i increases, the preset cooling time CD(i) increases correspondingly, thus minimizing a negative impact caused by the frequent on and off of the LED light string body in the short period of time.

Please refer to FIG. 5, FIG. 5 is a specific schematic structural diagram of the circuit of the control board of the LED light string driver in Embodiment 1 of the present application.

In this embodiment, the light string body 21 includes a red light emitting unit, a green light emitting unit and a blue light emitting unit. The number of the LED driving module E3 is three, which are a first LED driving module E31, a second LED driving module E32 and a third LED driving module E33. The master control chip MCU outputs a first PWM signal PWM1, a second PWM signal PWM2 and a third PWM signal PWM3 to the first LED driving module E31, the second LED driving module E32 and the third LED driving module E33, respectively. The first LED driving module E31, the second LED driving module E32 and the third LED driving module E33 drive the red light emitting unit, the green light emitting unit and the blue light emitting unit of the light string body 21 according to the first PWM signal PWM1, the second PWM signal PWM2 and the third PWM signal PWM3, respectively. The master control chip MCU controls a luminance ratio of the red light emitting unit, the green light emitting unit and the blue light emitting unit of the light string body 21 through controlling the first PWM signal PWM1, the second PWM signal PWM2 and the third PWM signal PWM3, thus synthesizing luminous effects with any color, any brightness luminous effect.

Specifically, the power supply voltage stabilizing module E1 includes: a first voltage stabilizing unit E11 and a second voltage stabilizing unit E12. The first voltage stabilizing unit E11 is configured to convert the external DC power supply DC+ into a first voltage V1, thus supplying power to the remote control unit E22 and the master control chip MCU. The second voltage stabilizing unit E12 is configured to convert the external DC power supply DC+ into a second voltage V2, thus supplying power to the LED driving module E3.

A specific voltage value of the external DC power supply DC+ is between 3V˜36V; specific voltage values of the first voltage V1 and the second voltage V2 are set according to actual needs. In this embodiment, the external DC power supply DC+ is a +5.5V power supply, the first voltage V1 is +5V, the second voltage V2 is +2V.

The first voltage stabilizing unit E11, includes: a first voltage stabilizing chip U11, a first capacitor C1, a first diode D1 and a second capacitor C2. An input terminal VIN of the first voltage stabilizing chip U11 is connected to the external DC power supply DC+ (+5.5V power supply), an output terminal VOUT of the first voltage stabilizing chip U11 outputs the first voltage V1 (+5V power supply), a ground terminal GND of the first voltage stabilizing chip U11 is grounded. The first capacitor C1 is connected between the input terminal VIN and the output terminal VOUT of the first voltage stabilizing chip U11. A cathode of the first diode D1 is connected to the external DC power supply DC+ (+5.5V power supply), an anode of the first diode D1 is grounded. The second capacitor C2 is connected between the output terminal VOUT and the ground terminal GND of the first voltage stabilizing chip U11. Both the capacitor C11, the first diode D1 and the second capacitor C2 are configured to stabilize voltage and protect the circuit.

The second voltage stabilizing unit E12 includes: a first voltage stabilizing triode Q1, a first resistor R1, a second resistor R2, a three-pins voltage regulating tube Z1, a third resistor R3, a fourth resistor R4 and a third capacitor C3. The first voltage stabilizing triode Q1 is a NPN triode, a collector of the first voltage stabilizing triode Q1 is connected to the external DC power supply DC+ (+5.5V power supply) through the first resistor R1, a base of the first voltage stabilizing triode Q1 is connected to the collector of the first voltage stabilizing triode Q1 through the second resistor R2, an emitter of the first voltage stabilizing triode Q1 is an output terminal of the second voltage (+2V power supply). A first pin of the three-pins voltage regulating tube Z1 is connected to the emitter of the first voltage stabilizing triode Q1 through the third resistor R3, a second pin (a cathode) of the three-pins voltage regulating tube Z1 is connected to the base of the first voltage stabilizing triode Q1, a third pin (an anode) of the three-pins voltage regulating tube Z1 is grounded. The fourth resistor R4 is connected between the first pin and the third pin of the three-pins voltage regulating tube Z1. One end of the third capacitor C3 is connected to the emitter of first voltage stabilizing triode Q1, the other end of the third capacitor C3 is grounded.

Specifically, the key control unit E21 is configured to receive the key signal KEY generated by the user triggering the key 203 and output the key signal KEY to the master control chip MCU.

Specifically, the remote control unit E22 includes a first radio frequency receiving chip U12, a fourth capacitor C4, an antenna ANT, a first crystal oscillator Y1, a fifth resistor R5 and a sixth resistor R6. A radio frequency signal receiving terminal RFIN of first radio frequency receiving chip U12 is connected to the antenna ANT through the fourth capacitor C4 and is configured to receive a radio frequency signal sent by a remote controller provided externally. The first radio frequency receiving chip U12 is configured to convert the radio frequency signal into a remote control signal through a preset demodulation program and output the remote control signal to the master control signal to the master control chip through an output terminal DOUT of the first radio frequency receiving chip U12.

A model of the first radio frequency receiving chip U12 is CMT2210LB, a pin 1 and a pin 2 of first radio frequency receiving chip U12 are not connected, a pin 3 of first radio frequency receiving chip U12 is the output terminal DOUT connected to the master control chip MCU, a pin 4 of first radio frequency receiving chip U12 is a clock input terminal XIN connected to the first crystal oscillator Y1, a pin 5 of first radio frequency receiving chip U12 is the radio frequency signal receiving terminal RFIN connected to the antenna ANT, a pin 6 of first radio frequency receiving chip U12 is a ground terminal GND, a pin 7 of first radio frequency receiving chip U12 is a power supply input terminal VDD, pin 8 of first radio frequency receiving chip U12 is not connected. One end of the first crystal oscillator Y1 is connected to the clock input terminal XIN of the model of the first radio frequency receiving chip U12, the other end of the first crystal oscillator Y1 is grounded. The power supply input terminal VDD of the first radio frequency receiving chip U12 is connected to the first voltage V1 (+5V power supply) through the fifth resistor R5. The fifth capacitor C5 is connected between the ground terminal GND and the power supply input terminal VDD of the first radio frequency receiving chip U12. One end of the sixth resistor R6 is connected to the radio frequency signal receiving terminal RFIN of the first radio frequency receiving chip U12, the other end of the sixth resistor R6 is grounded.

Specifically, the master control chip MCU is provided with a program burning terminal, a power supply input terminal, a key signal input terminal, a remote control signal input terminal and a PWM signal output terminal. The program burning terminal is configured to be connected to a host computer provided externally to burn a preset program. The power supply input terminal is connected to the first voltage V1 output by the power supply voltage stabilizing module E1. The key signal input terminal is connected to the key signal KEY output by the key control unit E22. The remote control signal input terminal is connected to the remote control signal output by the first radio frequency receiving chip U12 of the remote control unit E21. The master control chip MCU is configured to generate the PWM signal configured to control the LED driving module E3 through an inner preset program according to the key signal and/or the remote control signal.

Specifically, the first LED driving module E31 includes a first MOS transistor MOS1, a seventh resistor R7, a second diode D2, an eighth resistor R8 and a sixth capacitor C6. The first MOS transistor MOS1 is a P-channel MOS transistor, a gate of the first MOS transistor MOS1 is connected to the first PWM signal PWM1 through the seventh resistor R7, a source of the first MOS transistor MOS1 is connected to the external DC power supply DC+ (+5.5V power supply), a drain of the first MOS transistor MOS1 is a first output terminal OUT1 configured to be connected to the red light emitting unit of the light string body. An anode of the second diode D2 is connected to the second voltage V2 output by the second voltage stabilizing unit E12, a cathode of the second diode D2 is connected to the drain of the first MOS transistor MOS1. The eighth resistor R8 is connected between the gate and the drain of the first MOS transistor MOS1. One end of the sixth capacitor C6 is connected to the gate of the first MOS transistor MOS1, the other end of the sixth capacitor C6 is grounded.

Specifically, the second LED driving module E32 includes a second MOS transistor MOS2, a ninth resistor R9, a third diode D3 and a tenth resistor R10. The second MOS transistor MOS2 is also a P-channel MOS transistor, a gate of the second MOS transistor MOS2 is connected to the second PWM signal PWM2 output by the master control chip MCU through the ninth resistor R9, a source of the second MOS transistor MOS2 is connected to the external DC power supply DC+ (+5.5V power supply), a drain of the second MOS transistor MOS2 is a second output terminal OUT2 connected to the green light emitting unit of the light string body. An anode of third diode D3 is connected to the second voltage V2 output by the second voltage stabilizing unit E12, a cathode of the third diode D3 is connected to the drain of the second MOS transistor MOS2. The tenth resistor R10 is connected between the gate and the source of the second MOS transistor MOS2.

Specifically, the third LED driving module E33 includes a third MOS transistor MOS3, an eleventh resistor R11, a fourth diode D4 and a twelfth resistor R12. The third MOS transistor MOS3 is also a P-channel MOS transistor, a gate of the third MOS transistor MOS3 is connected to the third PWM signal PWM3 output by the master control chip MCU through the eleventh resistor R11, a source of the third MOS transistor MOS3 is connected to the external DC power supply DC+ (+5.5V power supply), a drain of the third MOS transistor MOS3 is a third output terminal OUT3 connected to the blue light emitting unit of the light string body. An anode of the fourth diode D4 is connected to the second voltage V2 output by the second voltage stabilizing unit E12, a cathode of the fourth diode D4 is connected to the drain of the third MOS transistor MOS3. The twelfth resistor R12 is connected between the gate and the source of the third MOS transistor MOS3.

In this embodiment, a model of the master control chip MCU is 8S1K; a model of the first voltage stabilizing chip U11 is 7550; the first crystal oscillator Y1 is a 27M crystal oscillator; a model of both the first diode D1, the second diode D2, the third diode D3 and the fourth diode D4 is SS34; a model of the first voltage stabilizing triode Q1 is D882; a model of the three-pins voltage regulating tube Z1 is TL432; a model of both the first MOS transistor MOS1, the second MOS transistor MOS2, the third MOS transistor MOS3 and the fourth MOS transistor MOS4 is a 4435 p-channel MOS transistor. Specific parameters of other capacitors and resistors may be adjusted by those of ordinary skill in the art according to needs and are not limited in the present application.

### Embodiment 2

Embodiment 2 of the present application is basically the same as Embodiment 1 except that a specific structure of the circuit of the control board of the LED light string driver is different.

In this embodiment, the light string body 21 includes a white light emitting unit and a color light emitting unit. A first output terminal Lo1 configured to drive the white light emitting unit and a second output terminal Lo2 configured to drive the color light emitting unit are provided on the LED driving module E3. The master control chip MCU outputs a first PWM signal and a second PWM signal. The LED driving module E3 drives the white light emitting unit and the color light emitting unit of the light string body 21 according to the first PWM signal and the second PWM signal, respectively. The master control chip MCU controls a luminance ratio of the white light emitting unit and the color light emitting unit of the light string body 21 through controlling the first PWM signal and the second PWM signal.

Furthermore, both the white light emitting unit and the color light emitting unit of the light string body 21 are consisted of a plurality of LED lamp beads and a plurality of breathing flash bulbs. During power on, the plurality of LED lamp beads remain illuminated; the plurality of breathing flash bulbs remain illuminated when a current is less than a preset threshold and flash when the current is greater than the preset threshold. Specifically, a drive chip is provided in each breathing flash bulb of the plurality of breathing flash bulbs. The drive chip provided in the breathing flash bulb may detect whether the current reaches the preset threshold, when the current does not reach the preset threshold, the drive chip controls the plurality of breathing flash bulb to remain illuminated, and controls brightness of the breathing flash bulb according to a value of the current; when the current reaches the preset threshold, the drive chip controls the breathing flash bulb to perform a breathing type flash, that is, the breathing flash bulb is controlled to repeat a cycle of “brightening→brightest→dimming→darkest” according to a preset cycle.

In this embodiment, the preset threshold is 80% of a maximum rated current. When a duty cycle of the first PWM signal or the second PWM signal output by the master control chip MCU is greater than 80%, a current output by the first output terminal Lo1 or the second output terminal Lo2 is greater than 80% of a maximum rated current, meanwhile, the plurality of LED lamp beads remain illuminated and the plurality of breathing flash bulbs flash. When the current output by the first output terminal Lo1 or the second output terminal Lo2 is less than or equal to 80% of a maximum rated current, both the plurality of LED lamp beads and the plurality of breathing flash bulbs remain illuminated.

Please refer to FIG. 6, FIG. 6 is a specific schematic structural diagram of the circuit of the control board of the LED light string driver in Embodiment 2 of the present application.

Specifically, the power supply voltage stabilizing module E1 is configured to convert the external DC power supply DC+ into a third voltage V3 to supply power to the master control chip MCU and the remote control unit E22. The power supply voltage stabilizing module E1 includes: a fifth diode D5, a second voltage stabilizing chip U21 and a seventh capacitor C7. An anode of the fifth diode D5 is connected to the external DC power supply DC+, a cathode of the fifth diode D5 is connected to an input terminal of the second voltage stabilizing chip U21. A ground terminal of the second voltage stabilizing chip U21 is grounded, an output terminal of the second voltage stabilizing chip U21 outputs the third voltage V3. One end of the seventh capacitor C7 is connected to the output terminal of the second voltage stabilizing chip U21, the other end of the seventh capacitor C7 is grounded. A voltage of the external DC power supply is between 3V˜36V. a value of the third voltage V3 may be set according to actual needs. In this embodiment, the voltage of the external DC power supply DC+ is 29V, a value of the third voltage V3 is 3.3V.

Specifically, the key control unit E21 is connected to a key signal input terminal PA0 of the master control chip MCU. When the user triggers the key 203, the key control unit E21 obtains the key signal and outputs the key signal to the master control chip MCU.

Specifically, the remote control unit E22 includes: a second radio frequency receiving chip U22, an eighth capacitor C8, a first inductor L1, a second crystal oscillator Y2 and a ninth capacitor C9. A radio frequency receiving terminal RFIN of the second radio frequency receiving chip U22 is connected to a signal receiving antenna RF1 provided externally through the eighth capacitor C8. One end of the first inductor L1 is connected to the radio frequency signal receiving terminal RFIN of the second radio frequency receiving chip U22, the other end of the first inductor L1 is grounded. A remote control signal output terminal VOUT of the second radio frequency receiving chip U22 is connected to a remote control signal input terminal PC5 of the master control chip MCU. The second radio frequency receiving chip U22 is configured to obtain a radio frequency signal generated by the user operating the remote controller through the radio frequency receiving terminal RFIN of the second radio frequency receiving chip U22, then performs demodulation processing on the radio frequency signal to obtain the remote control signal, and output the remote control signal to the master control chip MCU through the remote control signal output terminal VOUT of the second radio frequency receiving chip U22.

A crystal oscillator connecting terminal XIN of the second radio frequency receiving chip U22 is connected to the second crystal oscillator Y2. One end of the second crystal oscillator Y2 is connected to the crystal oscillator connecting terminal XIN of the second radio frequency receiving chip U22, the other end of the second crystal oscillator Y2 is grounded. A power supply terminal VDD of the second radio frequency receiving chip U22 is connected to the third voltage V3. One end of the ninth capacitor C9 is connected to the power supply terminal VDD of the second radio frequency receiving chip U22, the other end of the ninth capacitor C9 is grounded.

Specifically, the master control chip MCU is provided with a power supply input terminal VDD, a first crystal oscillator connecting terminal PA6, a second crystal oscillator connecting terminal PA7, a first program burning terminal PA0, a second program burning terminal PA1, a key signal input terminal PA0, a remote control signal input terminal PC5, a first PWM signal output terminal PA4, a second PWM signal output terminal PA2 and a short-circuit detection terminal PC1.

The power supply input terminal VDD is connected to the third voltage V3 output by the power supply voltage stabilizing module E1. One end of the tenth capacitor C10 is connected to the power supply input terminal VDD of the master control chip MCU, the other end of the tenth capacitor C10 is grounded. The first crystal oscillator connecting terminal PA6 and the second crystal oscillator connecting terminal PA7 are connected to both ends of the first crystal oscillator Y1 to obtain a clock signal required for work. One end of the eleventh capacitor C11 is connected to the first crystal oscillator connecting terminal PA6, the other end of the eleventh capacitor is grounded. One end of the twelfth capacitor C12 is connected to the second crystal oscillator connecting terminal PA7, the other end of the twelfth capacitor C12 is grounded. The first program burning terminal PA0 and the second program burning terminal PA1 are configured to be connected to the host computer when burning program.

The key signal input terminal PA0 is connected to the key control unit E21 to obtain the key signal. The terminal PA0 of the master control chip MCU serves as the first program burning terminal during burning program, and serves as the key signal input terminal during normally operation. The remote control signal input terminal PC5 is connected to the remote control unit E22 to obtain the remote control signal. The first PWM signal output terminal PA4 and the second PWM signal output terminal PA2 output the first PWM signal and the second PWM signal to the LED driving module E3, respectively. The short-circuit detection terminal PC1 is grounded through the thirteenth resistor R13 to detect a current of the thirteenth resistor R13. When the current of the thirteenth resistor R13 is detected to exceed a set short-circuit threshold, the circuit may exist a short-circuit, at this time the master control chip MCU cut off outputs of the first PWM signal PA4 and the second PWM signal PA2, thus playing a short circuit protection effect.

Specifically, the LED driving module E3 includes: a first driving triode TR1, a second driving triode TR2, a fourteenth resistor R14, a fifteenth resistor R15, a sixteenth resistor R16, a sixth diode D6, a seventeenth resistor R17, an eighteenth resistor R18, a third driving triode TR3, a fourth driving triode TR4, a nineteenth resistor R19 and a twentieth resistor R20.

Both the first driving triode TR1 and the second driving triode TR2 are NPN triodes. A collector of the first driving triode TR1 is connected to the external DC power supply DC+, a base of the first driving triode TR1 is connected to the collector of the first driving triode TR1 through the fourteenth resistor R14, an emitter of the first driving triode TR1 is the first output terminal Lo1. A collector of the second driving triode TR2 is connected to the external DC power supply DC+, a base of the second driving triode TR2 is connected to the collector of the second driving triode TR2 through the fifteenth resistor R15, an emitter of the second driving triode TR2 is the second output terminal Lo2. The first output terminal Lo1 and the second driving triode TR2 are configured to be connected to the light string body 21. The sixteenth resistor R16 is connected between the first output terminal Lo1 and the second driving triode TR2. A cathode of the sixth diode D6 is connected to the base of the first driving triode TR1, an anode of the sixth diode D6 is connected to the emitter of the second driving triode TR2 through the seventeenth resistor R17. A cathode of the third diode D3 is connected to the base of the second driving triode TR2, an anode of the third diode D3 is connected to the emitter of the first driving triode TR1 through the eighteenth resistor.

Both the third driving triode TR3 and the fourth driving triode TR4 are PNP triodes. An emitter of the third driving triode TR3 is connected to the first output terminal Lo1, a collector of the third driving triode TR3 is grounded, a base of the third driving triode TR3 is connected to the first PWM signal output terminal PA4 of the master control chip MCU through the nineteenth resistor R19. An emitter of the fourth triode TR4 is connected to the second output terminal Lo2, a collector of the fourth triode TR4 is grounded, a base if the fourth triode TR4 is connected to the second PWM signal output terminal PA2 of the master control chip MCU through the twentieth resistor R20. The master control chip MCU controls the current output by the first output terminal Lo1 and the second output terminal Lo2 by controlling the duty cycle of the first PWM signal and the second PWM signal, thus controlling an effect of light emitted by the light string body 21 connected to the first output terminal Lo1 and the second output terminal Lo2.

In this embodiment, a model of the second voltage stabilizing chip U21 is SE8533, a model of the fifth diode D5 is SS34, a model of the second radio frequency receiving chip U22 is CMT2210LB, a model of the first driving triode TR1 and the second driving triode TR2 is B772, a model of the third driving triode TR3 and the fourth driving triode TR4 is D882, a model of the sixth diode D6 and a seventh diode D7 is ZMM6V2, a model of the master control chip MCU is 60s022.

The present application has the following technical effects: 1, The driver is separated from the LED light string body, and is connected to the LED light string body through the connecting terminal only in use. When the user decorates the Christmas tree, the user may first wrap the LED light string body with less weight around the Christmas tree, and then connect the LED light string body to the driver, thus improving the installation experience. 2, A false triggering preventing module is provided in the master control chip of the driver, the false triggering preventing module may prevent the LED light string from being turned on and off at frequent intervals due to a frequent false operation of the user, thus extending a service life of the LED light string and improving safety. 3, The user may control the effect of the light emitted by the LED light string through two methods, i.e., the key and the remote controller, which is suitable for various operation scenarios and more convenient to use. 4, The driver has a WRGB poleless dimming and color adjusting function, which may drive the LED light string to emit lights in any color and any brightness, thus making the effect of the light emitted by the LED light string more vibrant and improving the user experience.

The above-mentioned embodiments only represent several implementations of this application, and descriptions thereof are specific and detailed, but should not be construed as a limitation on the application scope of this patent. It should be noted that those of ordinary skill in the art may further make various modifications and improvements without departing from the concept of the disclosure, and the present disclosure is intended to include these modifications and improvements.

What is claimed:

1. A LED light string driver, comprising:
a housing, and a control board provided in the housing; wherein, a power supply terminal of the control board is connected to an external DC power supply, and an output terminal of the control board is connected to a light string body provided externally;
wherein, a circuit is provided on the control board, the circuit including a master control chip, and a control signal receiving module and a LED driving module electrically connected to the master control chip; the control signal receiving module is configured to receive a control signal generated by an operation of a user; the master control chip is configured to generate a PWM signal according to the control signal; the LED driving module is electrically connected to the light string body provided externally and is configured to drive the light string body to illuminate according to the PWM signal;
wherein, a false triggering preventing module is provided in the master control chip, the false triggering preventing module is configured to determine whether the LED light string driver is currently in a false triggering state, and perform a false triggering protection operation if the LED light string driver is currently in the false triggering state.

2. The LED light string driver of claim 1, wherein,
the false triggering preventing module includes a false triggering determining unit;
the false triggering determining unit is configured to perform the following steps to determine whether the LED light string driver is currently in the false triggering state:
S10, counting the number of times that the LED light string driver receives the control signal in a preset time period, and calculating a triggering frequency according to a length T of the preset time period and the number of times N that the LED light string driver receives the control signal; a calculation formula of the triggering frequency is:
$$f = \frac{N}{T} ,$$
wherein, f represents the triggering frequency, T represents the length of the preset time period, and N represents the number of times that the LED light string driver receives the control signal;
S20, comparing the triggering frequency with a preset frequency threshold; and if the triggering frequency is greater than the preset frequency threshold, determining that the LED light string driver is currently in the false triggering state.

3. The LED light string driver of claim 2, wherein, the false triggering preventing module includes a false triggering action unit;
wherein the false triggering action unit is configured to perform the following steps when the false triggering determining unit determines that the LED light string driver is currently in the false triggering state:
S30, controlling the LED light string driver to enter a cooling state lasting for a preset cooling time; when the LED light string driver is in the cooling state, the master control chip receives the control signal as usual without adjusting the PWM signal according to the control signal;
S40, invoking the false triggering determining unit after the preset cooling time ends to re-determine whether the LED light string driver is currently in the false triggering state;
S51, controlling the LED light string driver to re-enter the cooling state lasting for the preset cooling time if the false triggering determining unit still determines that the LED light string driver is currently in the false triggering state, and invoking the false triggering determining unit after the preset cooling time ends.

4. The LED light string driver of claim 3, wherein,
a cooling count i is defined to be initially equal to zero, and the preset cooling time is a function CD(i) of the cooling count i;
wherein the step S30 specifically includes: setting the cooling count i to be
i=i+1,
and controlling the LED light string driver to enter the cooling state lasting for a preset cooling time CD(i);
wherein the step S51 specifically includes: setting the cooling count i to be
i=i+1
if the false triggering determining unit still determines that the LED light string driver is currently in the false triggering state, and controlling the LED light string driver to re-enter the cooling state lasting for the preset cooling time CD(i), and invoking the false triggering determining unit after the preset cooling time CD(i) ends.

5. The LED light string driver of claim 4, wherein,
the following step is further included after S40:
S52, if the false triggering determining unit determines that the LED light string driver is not currently in the false triggering state, setting the cooling count i to zero, and invoking the false triggering determining unit.

6. The LED light string driver of claim 1, wherein,
the control signal receiving module includes a remote control unit electrically connected to the master control chip;
the control signal includes a remote control signal;
the remote control unit is configured to receive a radio frequency signal generated by an operation of a user on a remote controller, and perform demodulation processing on the radio frequency signal to obtain the remote control signal, and finally transmit the remote control signal to the master control chip.

7. The LED light string driver of claim 6, wherein,
a key is provided on the control board;
the control signal receiving module further includes a key control unit electrically connected to the master control chip;
the control signal further includes a key signal;
the key control unit is configured to obtain the key signal generated by the user triggering the key and output the key signal to the master control chip.

8. The LED light string driver of claim 7, wherein,
the number of the LED driving module is three, which are a first LED driving module, a second LED driving module and a third LED driving module;
the master control chip outputs a first PWM signal, a second PWM signal and a third PWM signal to the first LED driving module, the second LED driving module and the third LED driving module, respectively;
the first LED driving module, the second LED driving module and the third LED driving module drive a red light emitting unit, a green light emitting unit, a blue light emitting unit of the light string body according to the first PWM signal, the second PWM signal and the third PWM signal, respectively.

9. The LED light string driver of claim 8, wherein,
the circuit further includes a power supply voltage stabilizing module, the power supply voltage stabilizing module includes a second voltage stabilizing unit configured to transmit the external DC power supply into a second voltage;
the second voltage stabilizing unit includes: a first voltage stabilizing triode, a first resistor, a second resistor, a three-pins voltage regulating tube, a third resistor, a fourth resistor and a third capacitor; the first voltage stabilizing triode is a NPN triode, a collector of the first voltage stabilizing triode is connected to the external DC power supply through the first resistor, a base of the first voltage stabilizing triode is connected to the collector of the first voltage stabilizing triode, an emitter of the first voltage stabilizing triode is a second voltage output terminal; a first pin of the three-pins voltage regulating tube is connected to the emitter of the first voltage stabilizing triode through the third resistor, a second pin of the three-pins voltage regulating tube is connected to the base of the first voltage stabilizing triode, a third pin of the three-pins voltage regulating tube is grounded; the fourth resistor is connected between the first pin and the third pin of the three-pins voltage regulating tube; one end of the third capacity is connected to the emitter of the first voltage stabilizing triode, the other end of the third capacitor is grounded.

10. The LED light string driver of claim 9, wherein,
the first LED driving module includes: a first MOS transistor, a seventh resistor, a second diode, an eighth resistor and a sixth capacitor; the first MOS transistor is a P-channel MOS transistor, a gate of the first MOS transistor is connected to the first PWM signal output by the master control chip through the seventh resistor, a source of the first MOS transistor is connected to the external DC power supply, a drain of the first MOS transistor is a first output terminal connected to the red light emitting unit; an anode of the second diode is connected to the second voltage output by the second voltage stabilizing unit, a cathode of the second diode is connected to the drain of the first MOS transistor; the eighth resistor is connected between the gate and the source of the first MOS transistor; one end of the sixth capacitor is connected to the gate of the first MOS transistor, the other end of the sixth capacitor is grounded.

11. The LED light string driver of claim 10, wherein,
the power supply voltage stabilizing module further includes a first voltage stabilizing unit configured to convert the external DC power supply to a first voltage; the first voltage stabilizing unit includes: a first voltage stabilizing chip, a first capacitor, a first diode and a second capacitor; an input terminal of the first voltage stabilizing chip is connected to the external DC power supply, an output terminal of the first voltage stabilizing chip outputs the first voltage, a ground terminal of the first voltage stabilizing chip is grounded; the first capacitor is connected between the input terminal and the ground terminal of the first voltage stabilizing chip; a cathode of the first diode is connected to the external DC power supply, an anode of the first diode is grounded; the second capacitor is connected between the output terminal and the ground terminal of the first voltage stabilizing chip.

12. The LED light string driver of claim 11, wherein,
the remote control unit includes: a first radio frequency receiving chip, a fourth capacitor, an antenna, a first crystal oscillator, a fifth resistor, a fifth capacitor and a sixth resistor; a radio frequency signal receiving terminal of the first radio frequency receiving chip is connected to the antenna through the fourth capacitor and is configured to receive a radio frequency signal output by the remote controller; the first radio frequency receiving chip is configured to convert the radio frequency signal to the remote control signal through a preset demodulation program and transmit the remote control signal to the master control chip through the output terminal of the first radio frequency receiving chip; one end of the first crystal oscillator is connected to a clock input terminal of the first radio frequency receiving chip, the other end of the first crystal oscillator is grounded; a power supply input terminal of the first radio frequency receiving chip is connected to the first voltage through the fifth resistor; the fifth capacitor is connected between a ground terminal and the power supply terminal of the first radio frequency receiving chip; one end of the sixth resistor is connected to the radio frequency signal receiving terminal of the first radio frequency receiving chip, the other end of the sixth resistor is grounded.

13. The LED light string driver of claim 7, wherein,
the LED driving module is provided with a first output terminal and a second output terminal;
the master control chip is configured to output a first PWM signal and a second PWM signal to the LED driving module, respectively;
the LED driving module is configured to drive a white light emitting unit and a color light emitting unit through the first output terminal and the second output terminal according to the first PWM signal and the second PWM signal, respectively.

14. The LED light string driver of claim 13, wherein,
the LED driving module includes: a first driving triode, a second driving triode, a fourteenth resistor, a fifteenth resistor, a sixteenth resistor, a sixth diode, a seventeenth resistor, an eighteenth resistor, a third driving triode, a fourth driving triode, a nineteenth resistor and a twentieth resistor; both the first driving triode and the third driving triode are NPN triodes; a collector of the first driving triode is connected to the external DC power supply, a base of the first driving triode is connected to the collector of the first driving triode through the fourteenth resistor, an emitter of the fourteenth resistor is the first output terminal of the LED driving module; a collector of the second driving triode is connected to the external DC power supply, a base of the second driving triode is connected to the collector of the second driving triode through the fifteenth resistor, an emitter of the second driving triode is the second output terminal of the LED driving module; the sixteenth resistor is connected between the first output terminal and the second output terminal; a cathode of the sixth diode is connected to the base of the first driving triode, an anode of the sixth diode is connected to the emitter of the of the second driving triode through the seventeenth resistor; a cathode of the third diode is connected to the base of the second driving triode, an anode of the third diode is connected to the emitter of the first driving triode through the eighteenth resistor; both the third driving triode and the fourth driving triode are PNP triodes; an emitter of the third driving triode is connected to the first output terminal, a collector of the third driving triode is grounded, a base of the third driving triode is connected to a first PWM signal output terminal of the master control chip through the nineteenth resistor; an emitter of the fourth driving triode is connected to the second output terminal, a collector of the fourth driving triode is grounded, a base of the fourth driving triode is connected to a second PWM signal output terminal of the master control chip through the twentieth resistor.

15. The LED light string driver of claim 14, wherein,
the power supply voltage stabilizing module is configured to convert the external DC power supply into a third voltage; the power supply voltage stabilizing module includes: a fifth diode, a second voltage stabilizing chip and a seventh capacitor; an anode of the fifth triode is connected to the external DC power supply, a cathode of the fifth diode is connected to an input terminal of the second voltage stabilizing chip; a ground terminal of the second voltage stabilizing chip is grounded, an output terminal of the second voltage stabilizing chip outputs the third voltage; one end of the seventh capacitor is connected to the output terminal of the second voltage stabilizing chip, the other end of the seventh capacitor is grounded.

16. The LED light string driver of claim 15, wherein,
the remote control unit includes: a second radio frequency receiving chip, an eighth capacitor, a first inductor, a second crystal oscillator and a ninth capacitor; a radio frequency receiving terminal of the second radio frequency receiving chip is connected to an external signal receiving antenna through the eighth capacitor; one end of the first inductor is connected to a signal receiving terminal of the second radio frequency receiving chip, the other end of the first inductor is grounded; a remote control signal output terminal of the second radio frequency receiving chip is connected to a remote control signal input terminal of the master control chip; the second radio frequency receiving chip is configured to obtain the radio frequency signal through the radio frequency receiving terminal of the second radio frequency receiving chip, then perform demodulation processing on the radio frequency signal to obtain the remote control signal, and output the remote control signal to the master control chip through the remote control signal output terminal of the second radio frequency receiving chip; one end of the second crystal oscillator is connected to a crystal oscillator connecting terminal of the second radio frequency receiving chip, the other end of the second crystal oscillator is grounded; a power supply terminal of the second radio frequency receiving chip is connected to the third voltage; one end of the ninth capacitor is connected to the power supply terminal of the second radio frequency receiving chip, the other end of the ninth capacitor is grounded.

17. A LED light string, comprising: a light string body and the LED light string driver of claim 1; wherein, an input terminal of the LED light string driver is connected to an external DC power supply, an output terminal of the LED light string driver is connected to the light string body to drive the light string body to illuminate.

18. The LED light string of claim 17, wherein,
the light string body includes a plurality of LED light beads and a plurality of breathing flash bulbs, when power on, the plurality of LED light beads remaining illuminated, the plurality of breathing flash bulbs remaining illuminated when a current is less than a preset threshold and flashing when the current is greater than the preset threshold.

19. A Christmas tree, comprising:
a Christmas tree body and a LED light string wrapped on the Christmas tree body;
wherein, the LED light string includes: a light string body and the LED light string driver of claim 1; an input terminal of the LED light string driver is connected to an external DC power supply, an output terminal of the LED light string driver is connected to the light string body to drive the light string to illuminate.
